(19) United States
(12) Patent Application Publication
(10) Pub. No.: US 2013/0145628 A1
(43) Pub. Date: Jun. 13, 2013

(54) SNIPS INCLUDING A JAW STOP

(71) Applicant: Milwaukee Electric Tool Corporation, Brookfield, WI (US)

(72) Inventor: Daniel H. Schneider, Franklin, WI (US)

(73) Assignee: MILWAUKEE ELECTRIC TOOL CORPORATION, Brookfield, WI (US)

(21) Appl. No.: 13/706,842

(22) Filed: Dec. 6, 2012

Related U.S. Application Data
(60) Provisional application No. 61/568,204, filed on Dec. 8, 2011.
(60) Provisional application No. 61/700,975, filed on Sep. 14, 2012.

(51) Int. Cl. B23D 29/02

(52) U.S. Cl. CPC B23D 29/02
USPC 30/252; 30/244

(57) ABSTRACT

A hand tool for actuation between a closed state and an open state includes a first jaw member having a first blade portion and a first extension portion. The first blade portion defines a first cutting edge having a first substantially convex profile along its entire length. A first handle member is coupled to the first extension portion. A second jaw member is pivotably coupled to the first jaw member. The second jaw has a second blade portion and a second extension portion. The second blade portion includes a second edge having a second substantially convex profile along its entire length. A second handle member is coupled to the second extension portion. The first jaw member and the second jaw member define a jaw stop that inhibits the first blade portion and the second blade portion from opening beyond a predetermined jaw angle.

### CROSS REFERENCE TO RELATED APPLICATIONS

This application claims priority to U.S. Provisional Patent Application No. 61/568,204, filed Dec. 8, 2011, and U.S. Provisional Patent Application No. 61/700,975, filed Sep. 14, 2012, the entire contents of both of which are herein incorporated by reference.

### BACKGROUND OF THE INVENTION

The present invention relates to hand tools, and more particularly to metal snips.

Metal snips, also referred to as aviation snips, tin snips, or tinners, are a category of tools used to cut metal workpieces by shearing action. Metal snips are used for a variety of tasks in manufacturing and building construction, and may be subject to rough handling on a work site.

### SUMMARY OF THE INVENTION

In one embodiment, the invention provides a hand tool for actuation between a closed state and an open state. A first jaw member has a first blade portion and a first extension portion. The first blade portion defines a first cutting edge having a first substantially convex profile along its entire length. A first handle member is coupled to the first extension portion. A second jaw member is pivotably coupled to the first jaw member. The second jaw has a second blade portion and a second extension portion. The second blade portion includes a second edge having a second substantially convex profile along its entire length. A second handle member is coupled to the second extension portion. The first jaw member and the second jaw member define a jaw stop that inhibits the first blade portion and the second blade portion from opening beyond a predetermined jaw angle defined between the first cutting edge and the second cutting edge when the hand tool is in the open state.

In another embodiment, the invention provides a metal snips for cutting a workpiece of metal sheet by actuation between a closed state and an open state. A first jaw assembly has a first blade portion and a first extension portion. The first blade portion includes a first cutting edge having a first substantially convex profile. A first handle member is pivotably coupled to the first extension portion. A second jaw assembly member is pivotably coupled to the first jaw member. The second jaw member has a second blade portion and a second extension portion. The second blade portion includes a second cutting edge having a second substantially convex profile. A second handle member is pivotably coupled to the second extension portion and pivotably coupled to the first handle. The first jaw member and the second jaw member define a jaw stop that inhibits the first blade portion and the second blade portion from opening beyond a predetermined jaw angle defined between the first cutting edge and the second cutting edge when the metal snips are in the open state.

Other aspects of the invention will become apparent by consideration of the detailed description and accompanying drawings.

### BRIEF DESCRIPTION OF THE DRAWINGS

FIG. 1 is a side view of a hand tool according to one construction of the invention, with first and second jaw assemblies in a closed state.

FIG. 2 is a side view of the hand tool of FIG. 1, with the first and second jaw assemblies in an open state.

FIG. 3 is a perspective view of the first jaw assembly of the hand tool of FIGS. 1-2.

FIG. 4 is a perspective view of the second jaw assembly of the hand tool of FIGS. 1-2.

FIG. 5 is another perspective view of the second jaw assembly.

FIG. 6 is a side view of a hand tool according to another construction of the invention, with first and second jaw assemblies in a closed state.

FIG. 7 is an enlarged perspective view of the hand tool of FIG. 6 with the jaw assemblies in the closed state.

FIG. 8 is a side view of the hand tool of FIG. 6 with the jaw assemblies in an open state.

FIG. 9 is an enlarged perspective view of the hand tool of FIG. 6 with the jaw assemblies in an open state.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

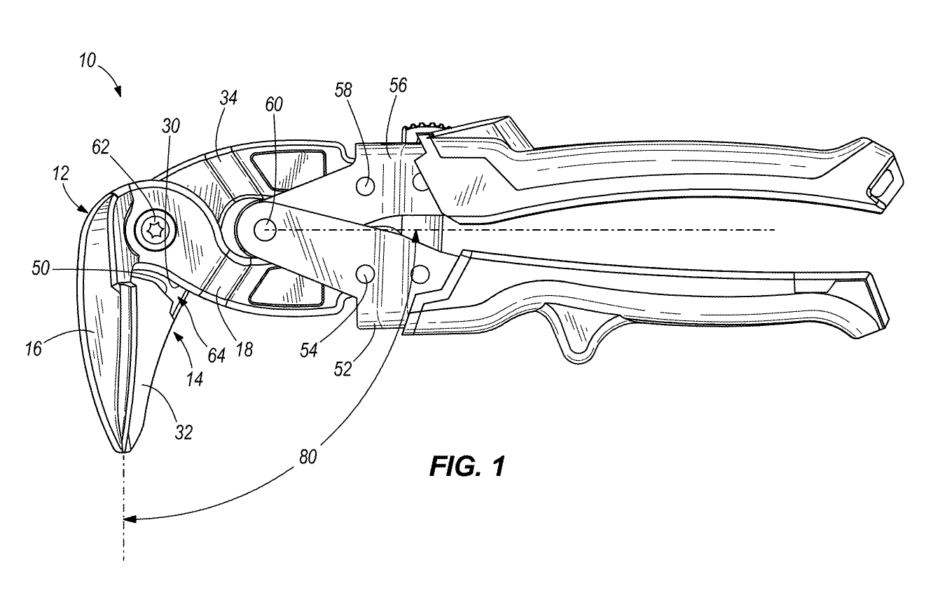

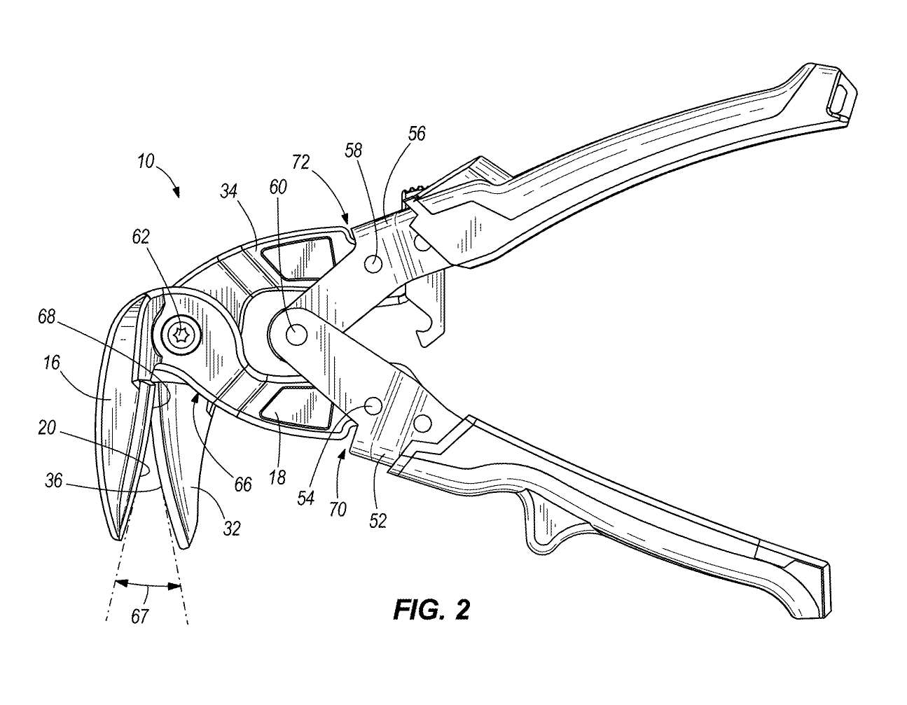

FIG. 1 illustrates a hand tool, more specifically, a snips 10. The snips 10 is user-actuated between an open configuration (FIG. 2) and a closed configuration (FIG. 1) for cutting sheet metal and work pieces of other materials. The snips 10 includes a first jaw assembly 12 and a second jaw assembly 14.

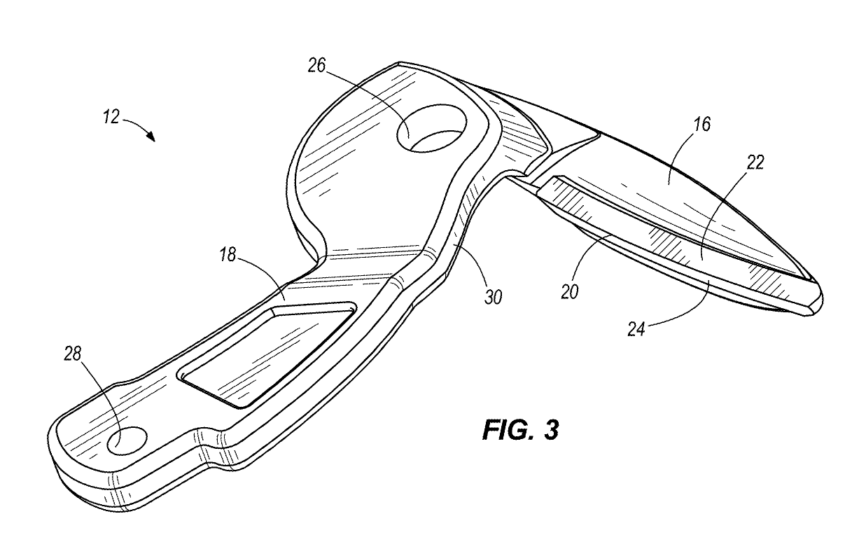

Referring to FIG. 3, the first jaw assembly 12 includes a first blade portion 16 and a first extension portion 18. The first blade portion 16 and first extension portion 18 are unitarily formed as one piece by forging, casting, machining, or combinations thereof

The first blade portion 16 defines a first cutting edge 20. Referring to FIG. 2, the first cutting edge 20 has a convex profile along its entire length. Referring to FIG. 3, the first cutting edge 20 is defined by a first shearing surface 22 and a first intersecting surface 24. At least the first shearing surface 22 is a machined (e.g., ground) surface, though in some constructions the first shearing surface 22 and first intersecting surface 24 are both machined surfaces. In other constructions, the first intersecting surface 24 is defined by an un-machined surface.

The first extension portion 18 defines a first blade pivot aperture 26 and a first handle pivot aperture 28. The first extension portion 18 further defines a first jaw stop surface 30.

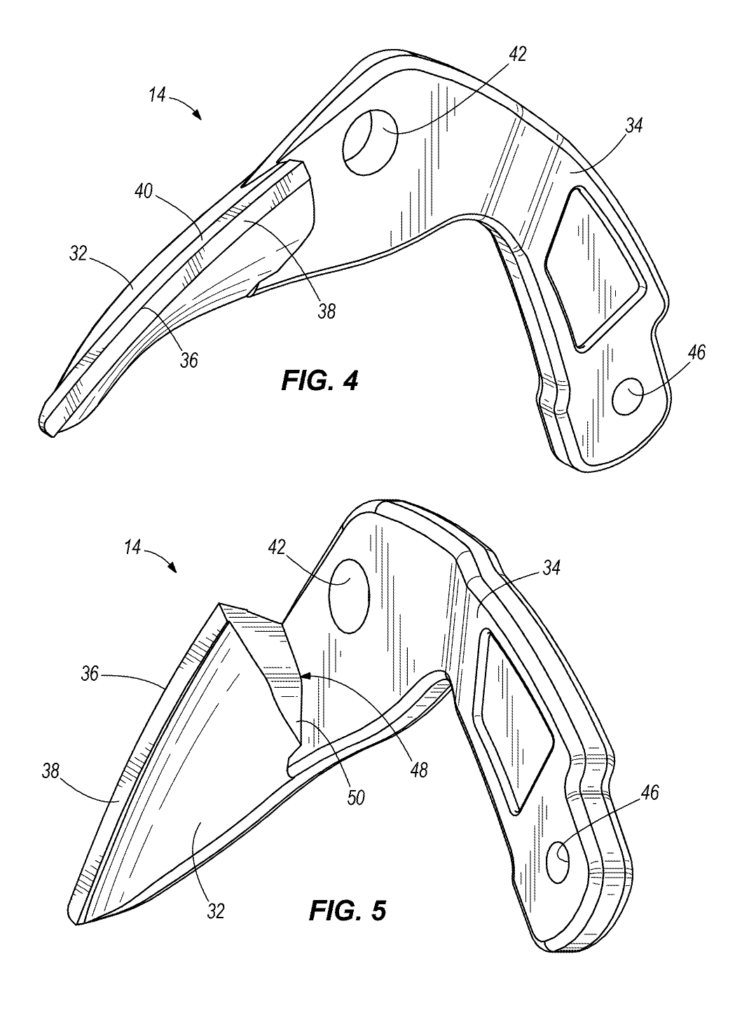

Referring to FIG. 4, the second jaw assembly 14 includes a second blade portion 32 and a second extension portion 34. The second blade portion 32 and the second extension portion 34 are unitarily formed as one piece by forging, casting, machining, or combinations thereof

The second blade portion 32 defines a second cutting edge 36. Referring to FIG. 2, the second cutting edge 36 has a convex profile along its entire length. Referring to FIG. 4, the second cutting edge 36 is defined by a second shearing surface 38 and a second intersecting surface 40. At least the second shearing surface 38 is a machined (e.g., ground) surface, though in some constructions the second shearing surface 38 and the second intersecting surface 40 are both machined surfaces. In other constructions, the second intersecting surface 40 is defined by an un-machined surface.

Referring to FIG. 5, the second extension portion 34 defines a second blade pivot aperture 42 and a second handle pivot aperture 46. A junction wall 48 between the second blade portion 32 and the second extension portion 34 defines a second jaw stop surface 50.

Referring to FIGS. 1-2, the first extension portion 18 is pivotally coupled to a first handle 52 about a first handle pivot pin 54 extending through the first handle pivot aperture 28 (FIG. 3). The second extension portion 34 is pivotally coupled to a second handle 56 about a second handle pivot pin 58 extending through the second handle pivot aperture 46 (FIGS. 4-6). Referring to FIGS. 1-2, the first handle 52 and the second handle 56 are pivotally coupled to each other about a central pivot pin 60. The first jaw assembly 12 and the second jaw assembly 14 pivot with respect to each other about a jaw pivot assembly 62, extending through the first blade pivot aperture 26 (FIG. 3) and the second blade pivot aperture 42 (FIGS. 4-5).

With the tool 10 in a closed configuration (FIG. 1), the first blade stop surface 30 and the second blade stop surface 50 are facing each other and substantially adjacent, with a gap 64 there between.

With the tool in an open configuration (FIG. 2), the first jaw stop surface 30 contacts the second jaw stop surface 50, defining a jaw stop 66. The stop 66 substantially inhibits the first blade portion 16 and the second blade portion 32 from opening beyond a desired maximum jaw angle 67. With the jaw angle at 67, the first blade portion 16 and the second blade portion 32 define a blade overlap area 68. The blade overlap area 68 substantially inhibits the first cutting edge 20 from crossing over the second cutting edge 36, a condition that could render the tool 10 inoperable.

Still referring to FIG. 2, with the jaw angle at 67, a first handle gap 70 is defined between the first handle 52 and the first extension portion 18. A second handle gap 72 is defined between the second handle 56 and the second extension portion 34.

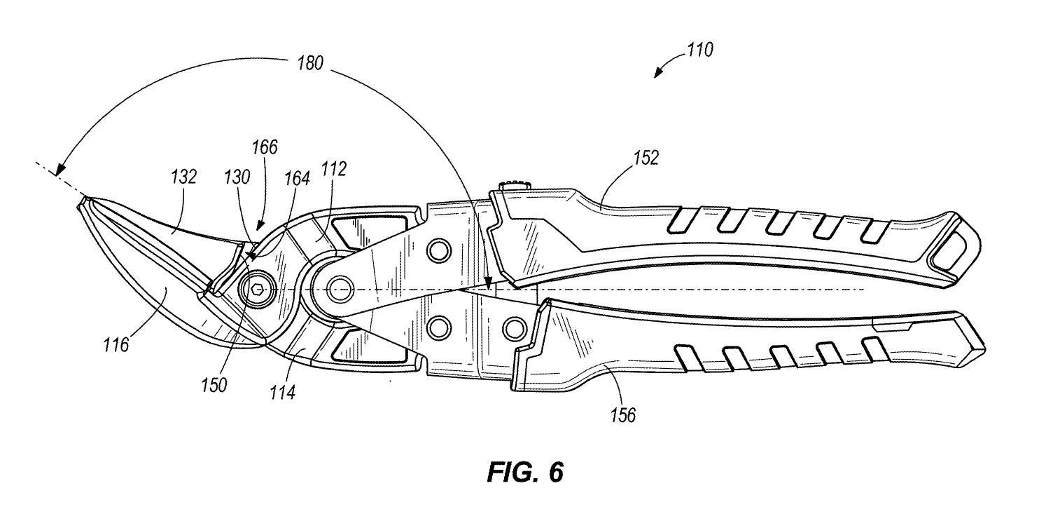

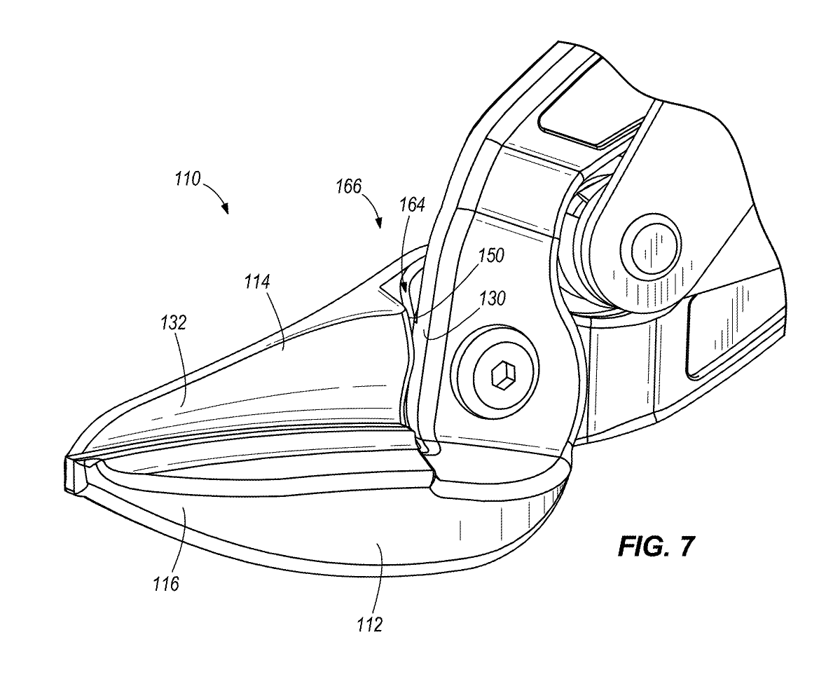

FIGS. 6-9 illustrate a snips 110 according to another construction of the invention. The snips 110 includes features similar to the snips 10 of FIGS. 1-5 and like components have been given like reference numbers plus 100. Only differences between the snips 10 and 110 will be discussed in detail below. When the snips 10 are in the closed configuration, the handles 52 and 56 of the snips 10 of FIGS. 1-5 are configured at an angle 80 (FIG. 1) with respect to the blade portions 16 and 32. The illustrated angle 80 is about 90 degrees and therefore, the snips 10 is an upright style snips. In the embodiment illustrated in FIGS. 6-9, when the snips 110 are in a closed configuration, handles 152 and 156 of the snips 110 are configured an angle 180 (FIG. 6) with respect to blade portions 116 and 132. The illustrated angle 180 is about 150 degrees and therefore, the snips 110 is an offset style snips. The snips 110 includes a jaw stop 166 similar to the jaw stop 66 discussed above with respect to the snips 10. Accordingly, the jaw stops 166 and 66 can be utilized in both an upright style snips and an offset style snips.

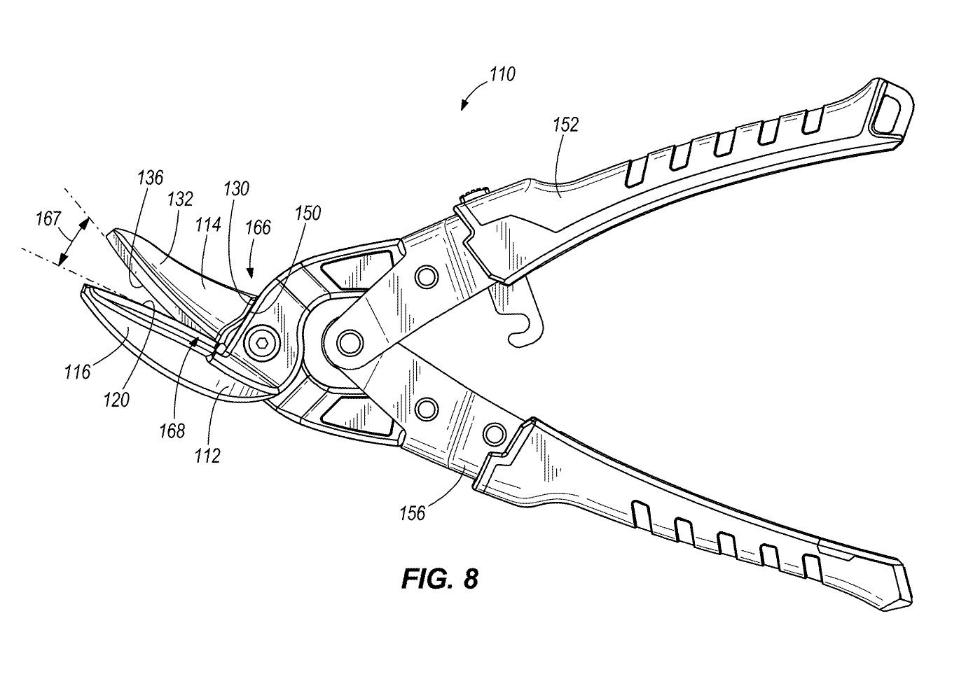

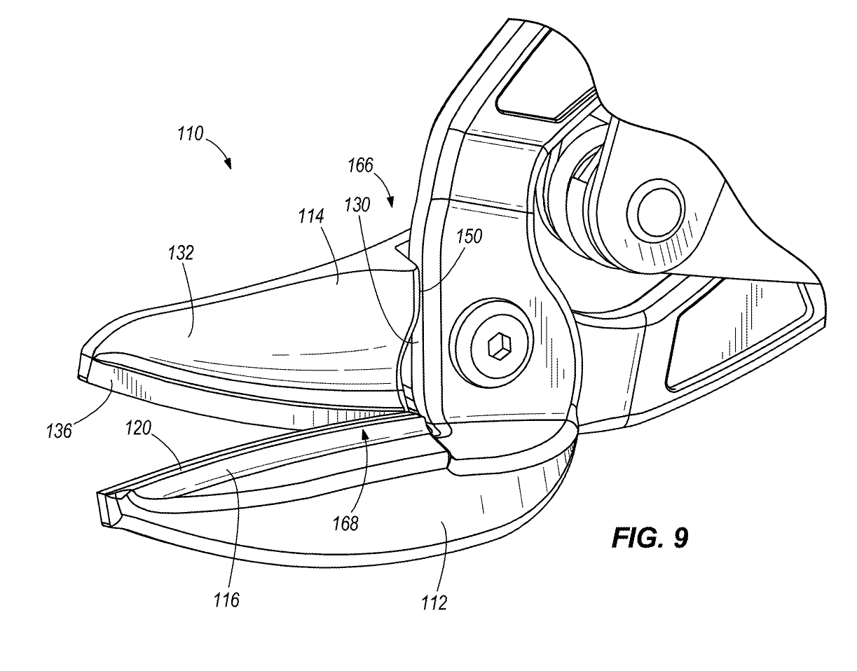

The snips 110 includes a first jaw assembly 112 and a second jaw assembly 114. The first jaw assembly 112 includes a first jaw stop surface 130 and the second jaw assembly 114 includes a second jaw stop surface 150. With the tool 110 in a closed configuration (FIG. 6), the first blade stop surface 130 and the second blade stop surface 150 are facing each other and substantially adjacent, with a gap 164 there between. With the tool 110 in an open configuration (FIG. 8), the first jaw stop surface 130 contacts the second jaw stop surface 150, defining the jaw stop 166. The blade stop 166 substantially inhibits the first blade portion 116 and the second blade portion 132 from opening beyond a desired maximum jaw angle 167. With the jaw angle at 167, the first blade portion 116 and the second blade portion 132 define a blade overlap area 168. The blade overlap area 168 substantially inhibits a first cutting edge 120 from crossing over a second cutting edge 136, a condition that could render the tool 110 inoperable.

Thus, the invention provides, among other things, a hand tool. Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A hand tool for actuation between a closed state and an open state, the hand tool comprising:
a first jaw member having a first blade portion and a first extension portion, the first blade portion defining a first cutting edge having a first substantially convex profile along its entire length;
a first handle member coupled to the first extension portion;
a second jaw member pivotably coupled to the first jaw member, the second jaw having a second blade portion and a second extension portion, the second blade portion including a second cutting edge having a second substantially convex profile along its entire length; and
a second handle member coupled to the second extension portion,
wherein the first jaw member and the second jaw member define a jaw stop that inhibits the first blade portion and the second blade portion from opening beyond a predetermined jaw angle defined between the first cutting edge and the second cutting edge when the hand tool is in the open state.

2. The hand tool of claim 1, wherein the first handle is pivotably coupled to the first extension portion.

3. The hand tool of claim 1, wherein the second handle is pivotably coupled to the second extension portion.

4. The hand tool of claim 1, wherein the first handle is pivotably coupled to the second handle.

5. The hand tool of claim 1, wherein the first jaw member is unitarily formed as one piece.

6. The hand tool of claim 1, wherein the second jaw member is unitarily formed as one piece.

7. The hand tool of claim 1, wherein the first extension portion defines a blade pivot aperture, the first jaw member coupled to the second jaw member about a pivot member extending through the blade pivot aperture.

8. The hand tool of the claim 1, wherein the first cutting edge is defined by a first machine-finished surface and a second machine-finished surface.

9. The hand tool of claim 8, wherein the second cutting edge is defined by a third machine-finished surface.

10. The hand tool of claim 9, wherein the jaw stop maintains the first machine finished surface in contact with the third machine finished surface when the first blade portion and the second blade portion are at the predetermined jaw angle.

11. The hand tool of claim 1, wherein a first junction wall between the first blade portion and the first extension portion includes a first jaw stop surface of the jaw stop.

12. The hand tool of claim 11, wherein a second junction wall disposed between the second blade portion and the second extension portion includes a second jaw stop surface, wherein contact between the first jaw stop surface and the second jaw stop surface establishes the predetermined jaw angle.

13. A metal snips for cutting a workpiece of metal sheet by actuation between a closed state and an open state, comprising:
a first jaw assembly having a first blade portion and a first extension portion, the first blade portion including a first cutting edge having a first substantially convex profile;
a first handle member pivotably coupled to the first extension portion;
a second jaw assembly member pivotably coupled to the first jaw member, the second jaw member having a second blade portion and a second extension portion, the second blade portion including a second cutting edge having a second substantially convex profile; and
a second handle member pivotably coupled to the second extension portion and pivotably coupled to the first handle,
wherein the first jaw member and the second jaw member define a jaw stop that inhibits the first blade portion and the second blade portion from opening beyond a predetermined jaw angle defined between the first cutting edge and the second cutting edge when the metal snips are in the open state.

14. The metal snips of claim 13, wherein the first jaw assembly includes a junction wall disposed between the first blade portion and the first extension portion, the junction wall defining a first jaw stop surface of the jaw stop.

15. The metal snips of claim 14, wherein the second jaw assembly defines a second jaw stop surface of the jaw stop, and wherein contact between the first jaw stop surface and the second jaw stop surface establishes the predetermined jaw angle.

16. The metal snips of claim 13, wherein the first cutting edge and second cutting edge overlap when the first blade portion and second blade portion are opened to the predetermined jaw angle.

17. The metal snips of claim 13, wherein first cutting edge is defined by a first machine finished surface and a second machine finished surface, and the second cutting edge is defined by a third machine finished surface.

18. The metal snips of claim 17, wherein the predetermined jaw angle maintains the first machine finished surface in substantial contact with the third machine finished surface.

19. The metal snips of claim 13, wherein the first blade assembly is unitarily formed as one piece.

20. The metal snips of claim 19, wherein the second blade assembly is unitarily formed as one piece.
